(19) United States
(12) Patent Application Publication
(10) Pub. No.: US 2024/0344595 A1
(43) Pub. Date: Oct. 17, 2024

(54) DUAL ARM TENSIONER WITH HYDRAULIC STRUT

(71) Applicant: FCA US LLC, Auburn Hills, MI (US)

(72) Inventors: Kevin J. Walker, Macomb, MI (US); Christopher F. Riddick, West Bloomfield, MI (US); Carl J. Stieler, West Bloomfield, MI (US); Joseph W. Zamm, Oakland, MI (US)

(21) Appl. No.: 18/298,537

(22) Filed: Apr. 11, 2023

(51) Int. Cl. F16H 7/12; F02N 11/04

(52) U.S. Cl. CPC F16H 7/1281; F02N 11/04; F16H 2007/0812; F16H 2007/0865; F16H 2007/0893; F16H 2007/0897

(57) ABSTRACT

A belt tensioner system for a belt starter generator has a first belt tensioner with a first fluid operated strut. A first arm is coupled with the first strut and has a pulley to tension a belt. A pivot fixes the first arm on the belt starter generator for pivotal movement so that the strut moves unidirectionally pivoting the first arm toward a first side of the belt to apply tension on the belt via the pulley. A second belt tensioner has a second fluid operated strut. A second arm is coupled with the second strut and has a pulley to tension the belt. A pivot for fixing the second arm on the belt starter generator for pivotal movement such that the second strut moves unidirectionally pivoting the second arm toward a second side of the belt to apply tension on the belt via the pulley.

### FIELD

The present disclosure relates to an automotive front end accessory drive systems and, more particularly, to a brackletless dual arm belt tensioner.

### BACKGROUND

This section provides background information related to the present disclosure which is not necessarily prior art.

Previously solutions exist to eliminate belt slippage and ejection concerns. One solution includes an integral dual arm tensioner. This style of tensioner utilizes two arms without any hydraulics. Another solution is a dual arm tensioner with a hydraulic strut that is mounted onto a bracket. Also, a series of two rotary arm tensioners, one on each side of the belt starter generator could be used to control belt tensions.

The drawback of using the prior art dual tensioners is that they have very low damping and do not control belt tensions during the belt starter generator torque reversals. The drawback of the dual hydraulic tensioner is the unnecessary cost and weight of the bracket. Dual rotary tensioners have higher damping effects than dual arm tensioners but may still not have enough damping force. Plus, they are harder to find packaging space in the motor or engine compartment. Accordingly, it desirable to overcome the disadvantages of the prior art.

The bidirectional movement from the belt starter generator motor during boosting and regenerative operation, coupled with driveline resonance and rear differential wheel hop all impart significant dynamic input into the front end accessory drive system which manifests as belt slippage and belt ejection from the drive. A typical mechanical, rotary style tensioner nor a singular hydraulic tensioner provide sufficient damping to attenuate the dynamic response of the front end accessory drive system belt. Thus, it is desirable to provide a dual hydraulic tensioner with independent tensioning arms working in unison to counteract the inputs from the belt starter generator motor, driveshaft, and rear differential. This effectively provides a robust front end accessory drive system belt control.

The belt starter generator motor has the ability to deliver torque to the front end accessory drive system allowing belt starting as well as adding additional torque to the engine during acceleration. It can also operate in the regenerative mode absorbing torque during braking and recharging.

### SUMMARY

This section provides a general summary of the disclosure, and is not a comprehensive disclosure of its full scope or all of its features.

The present disclosure provides a resistance to compression from the hydraulic strut offering better control of belt tensions on one side of the belt starter generator while also maintaining sufficient tension on the opposite side during torque reversals. Also, the present design provides weight savings and reduced packaging zones. The present disclosure creates more damping in the system when force is applied but also reacts quickly to take up slack when needed. The present design utilizes the belt starter generator for its mounting features.

Accordingly, the compact bracketless design provides weight savings, cost savings and enables the design to be packaged into a larger variety of under hood vehicle environments versus the prior bracketed versions. The present disclosure provides approved control to enable optimum belt starter generation performance. This results in less belt slip, lower belt span vibration and maintains adequate belt tensioning which eliminates belt ejections. Also, the consistency of the damping on the hydraulic struts throughout component life enables lower belt tensions thus reducing friction and improving economy.

According to a first aspect of the disclosure, a belt tensioner system for a belt starter generator comprises a first and second tensioner. The first belt tensioner includes a first fluid operated strut. A first arm is coupled with the first strut and includes a pulley for tensioning a belt. A pivot pin fixes the first arm on the belt starter generator for pivotal movement so that as the strut rod moves unidirectional, it pivots the first arm toward a first side of the belt to apply tension on the belt via the pulley.

The second belt tensioner includes a second fluid operated strut, with a second arm coupled with the strut. A pulley is on the end of the arm for tensioning the belt. A pivot pin fixes the second arm to the belt starter generator for pivotal movement so that a rod of the second strut moves unidirectionally pivoting the second arm towards a second side of the belt to apply tension on the belt via the pulley. The first and second arms include projection members projecting at one end up the arms to receive the strut rod. The first and second arms have different configurations. One arm is longer than the other. Both the first and second arms include the pulley at one end and a pivot bore spaced from the other end to receive the pivot pin. A bushing is positioned in each pivot bore to enhance rotation of the arms. The pulleys of the first and second arms are positioned substantially opposite from one another on their respective sides of the belt. The pulley force of the first and second pulleys are substantially aligned to oppose one another in opposite directions.

According to a second aspect of the disclosure, a belt starter generator with a tensioning system comprises a housing for a generator. The housing includes a first support and a first and second boss. A belt tensioner system for the belt starter generator includes a first and second tensioner. The first belt tensioner includes a first fluid operated strut coupled with the first support. A first arm is coupled with the first strut and includes a pulley to tension the belt. A pivot pin fixes the first arm on the first boss of the belt starter generator for pivotal movement so that as the strut rod moves unidirectional, it pivots the first arm toward a first side of the belt to apply tension on the belt via the pulley.

The second belt tensioner includes a second fluid operated strut, with a second arm coupled with the strut. A pulley is on the end of the arm to tension the belt. A pivot pin fixes the second arm to the second boss on the belt starter generator for pivotal movement so that a rod of the second strut moves unidirectionally pivoting the second arm towards a second side of the belt to apply tension to the belt via the pulley. The first and second arms include a projection member projecting at one end of the arm to receive the strut rod. The first and second arms have different configurations. One arm is longer than the other. Both the first and second arms include the pulley at one end and a pivot bore spaced from the other end to receive the pivot pin. A bushing is positioned in each pivot bore enhancing rotation of the arms. The pulleys of the first and second arms are positioned substantially opposite to one another on their respective sides of the belt. The pulley force of the first and second pulleys are substantially aligned toward or opposing one another in opposite directions.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle engine with the belt tensioner system.

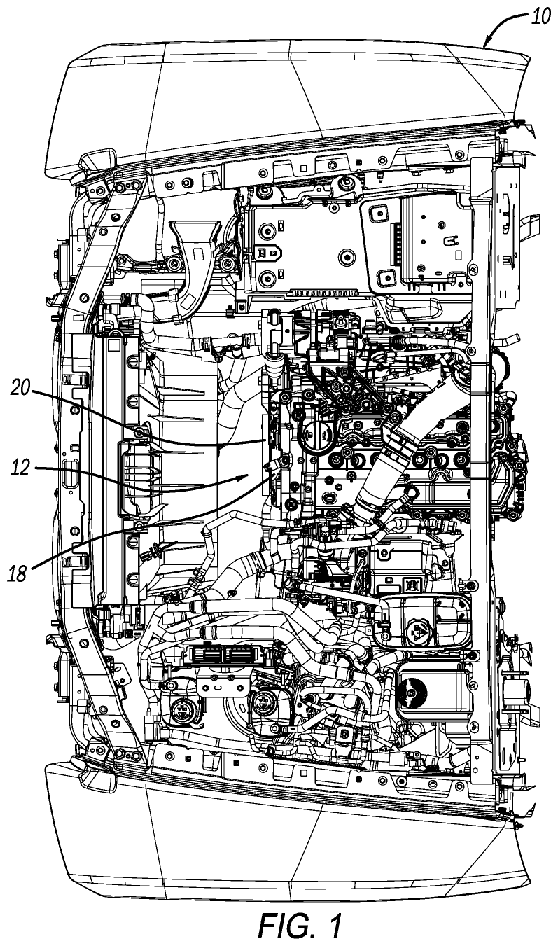

FIG. 2 is a front elevation view of the engine with the belt tensioning system.

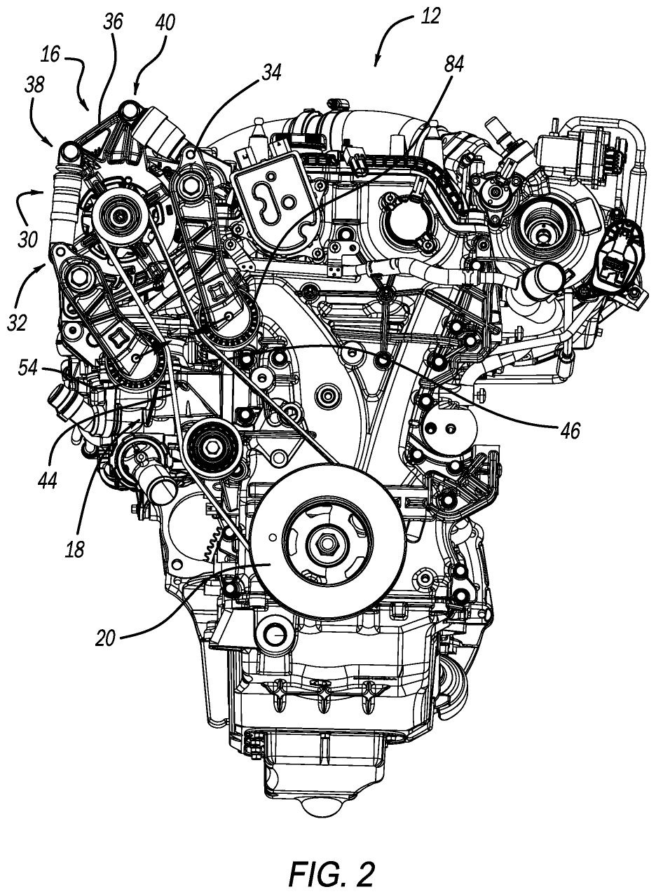

FIG. 3 is a perspective view of the belt tensioner on a belt starter generator motor.

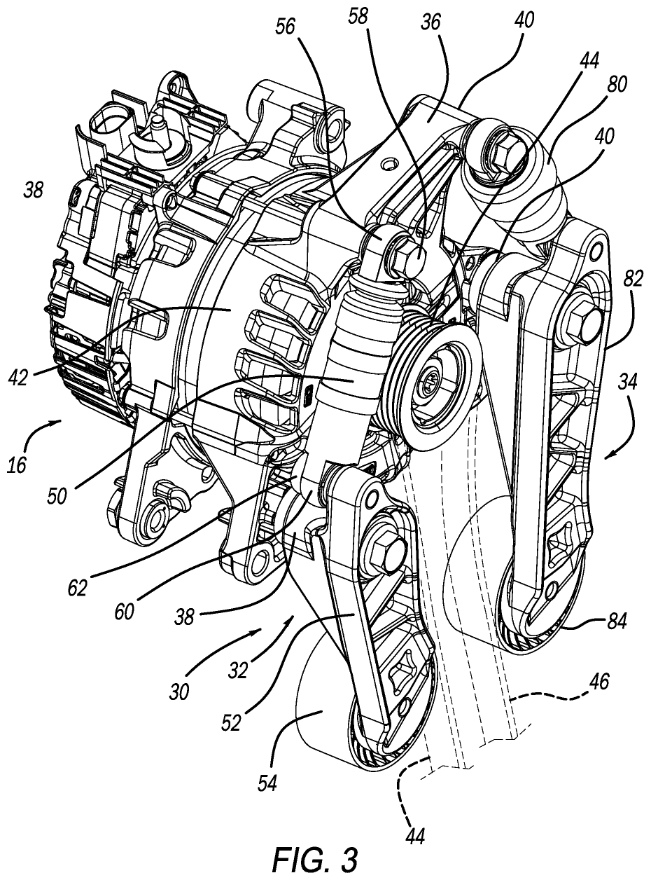

FIG. 4 is an exploded view of the belt tensioner system.

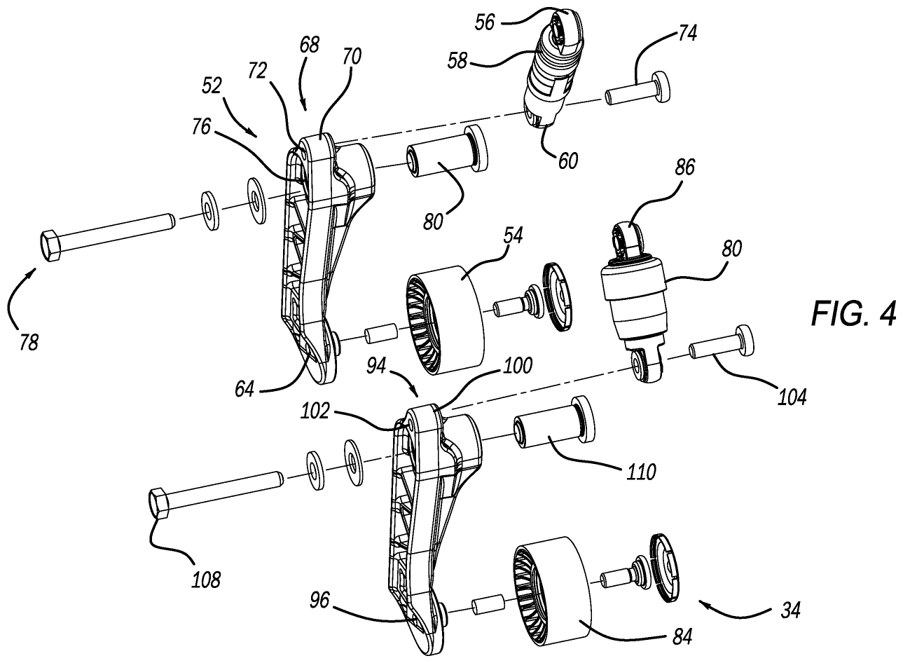

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle includes an engine 12 with a front end accessory drive system 14 that includes a belt starter generator motor 16, a belt 18 driven by a engine drive wheel 20. The belt starter generator 16 includes a brackletless dual arm tensioner 30.

The tensioner 30 includes a first tensioner arm 32 and a second tensioner arm 34. The tensioner arms 32, 34 are secured to a support 36 and respective boss 38, 40 to brackletlessly secure the tensioner arms 32, 34 onto the belt starter generator motor housing 42. The belt starter generator motor 16 includes a pulley 44 to receive the belt 18. The belt 18, as it is wrapped around the pulley 42, has a first side 44 and a second side 46.

The tensioning arm 32 includes a first strut 50 and a first arm 52. The arm 52 includes a pulley 54 to tension the belt 18. The strut 50 includes a first clevis 56 which receives a bolt 58 to secure the strut 50 to the support 36. A second clevis 60, on the strut 50, receives a bolt 62 that secures the strut 50 or strut rod with the first arm 52.

The first arm 52 has a first end 64 that includes a bore 66 to receive a bore that secures the pulley 54. The second end 68 includes a projection 70 with a bore 72 to receive a bolt 74 that secures the strut 50, via clevis 60, with the first arm 52. The arm 52 also includes a bore 76 that receives a bolt 78 to secure the arm 52 with the housing boss 38. Also, a bushing 79 is positioned in the boss bore to receive the bolt 78 to enhance arm rotation as the strut unidirectionally moves.

The second tensioning arm 34 includes a second strut 80 and a second arm 82. The second arm 82 includes a pulley 84 to tension the belt 18. The second strut includes a first clevis 80 that receives a bolt 88 to secure the strut 80 to the support 36. A second clevis 90, on the second strut 80, receives a bolt 92 that secures the strut 80 or strut rod with the second arm 82.

The second arm 82 has a first end 94 that includes a bore 96 to receive a bolt that secures the pulley 84. The second end 98 includes a projection 100 with a bore 102 to receive a bolt 104 that secures the second strut 80 with the second arm 82. The second arm 82 also includes a bore 106 that receives a bolt 108 to secure the second arm 82 with the housing boss 40. Also, a bushing 110 is positioned in the boss bore to receive the bolt 108 to enhance arm rotation as the strut 80 unidirectionally moves. Also, the second arm 82 is longer than the first arm 52.

The pulleys 54, 84 are positioned opposite to one another on their respective sides of the belt 18. The pulleys 54, 84 exert a tension onto the belt 18. The tensioning force of the pulleys 54, 84 are substantially aligned with one another in an opposing direction on the belt 18 to tension the belt as desired. Thus, the two tensioning arms 32, 34 work in unison to counteract the inputs from the belt starter generator motor, driveshaft and rear differential effectively to provide robust front end accessory drive belt control.

The resistant to compression from the hydraulic struts 50, 80 offer better control to belt tensions on one side of the belt starter generator motor while also maintaining sufficient tension on the opposite side of the belt during torque reversals. Also, the brackletless design provides weight saving, reduction and a reduced packaging zone. The hydraulic struts 50, 80 create more damping in the system when force is applied but also react quickly to take up slack when needed. Thus, the design provides optimal belt starter generator performance. This results in less slip, lower belt span vibration and maintains adequate belt tension which eliminates belt ejections. Also, the consistency of the damping on the hydraulic struts 50, 80 throughout component life enable lower belt tensions thus reducing friction and improving economy.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A belt tensioner system and a belt starter generator comprising:
a first belt tensioner including a first fluid operated strut secured to a support of the belt starter generator, a first arm coupled with the first strut including a first pulley for tensioning a belt, and a pivot pin fixing the first arm on the belt starter generator for pivotal movement so that the first strut moves unidirectionally pivoting the first arm toward a first side of the belt to apply tension on the belt via the first pulley;
a second belt tensioner including a second fluid operated strut secured to a support of the belt starter generator, a second arm coupled with the second strut including a second pulley for tensioning the belt, a pivot pin fixing the second arm on the belt starter generator for pivotal movement such that the second strut moves unidirectionally pivoting the second arm forward a second side of the belt to apply tension on the belt via the second pulley.

2. The belt tensioner system for a belt starter generator of claim 1, wherein the first and second arms including a projecting member at one end for receiving the respective strut.

3. The belt tensioner system for a belt starter generator of claim 1, wherein the first and second arms have different configurations.

4. The belt tensioner system for a belt starter generator of claim 1, wherein the first and second arms are elongated with two ends, one end having the pulley and a pivot bore, spaced from the other end, for receiving the pivot pin.

5. The belt tensioner system for a belt starter generator of claim 4, further comprising a bushing in each pivot bore enhancing rotation of the arms.

6. The belt tensioner system for a belt starter generator of claim 3, wherein one arm is longer than the other.

7. The belt tensioner system for a belt starter generator of claim 1, wherein the pulleys of the first and second arms substantially oppose one another on their respective sides of the belt.

8. The belt tensioner system for a belt starter generator of claim 7, wherein the pulley force of the first and second pulleys are substantially aligned within one another facing in opposite directions toward one another.

9. The belt tensioner system for a belt starter generator of claim 1, wherein one of the first and second struts is longer than the other.

10. A belt starter generator with a tensioning system comprising:
a housing for the generator motor, the housing including a support and a first and second boss;
a first belt tensioner including a first fluid operated strut coupled to the support, a first arm coupled with the first strut including a first pulley to tension a belt, and a pivot pin fixing the first arm on the belt starter generator housing boss for pivotal movement so that the strut moves unidirectionally pivoting the first arm toward a first side of the belt to apply tension on the belt via the first pulley; and
a second belt tensioner including a second fluid operated strut coupled to the support, a second arm coupled with the second strut including a second pulley to tension the belt, a pivot pin fixing the second arm on the belt starter generator housing boss for pivotal movement such that the second strut moves unidirectionally pivoting the second arm toward a second side of the belt to apply tension on the belt via the second pulley.

11. The belt starter generator with a tensioning system of claim 10, wherein the first and second arms include a projecting member at one end for receiving the strut.

12. The belt starter generator with a tensioning system of claim 10, wherein the first and second arms have different configurations.

13. The belt starter generator with a tensioning system of claim 10, wherein the first and second arms are elongated with two ends, one end having the pulley and a pivot bore, spaced from the other end, for receiving the pivot pin.

14. The belt starter generator with a tensioning system of claim 13, further comprising a bushing in each pivot bore enhancing rotation of the arms.

15. The belt starter generator with a tensioning system of claim 13, wherein one arm is longer than the other.

16. The belt starter generator with a tensioning system of claim 10, wherein the pulleys of the first and second arms substantially oppose one another on their respective sides of the belt.

17. The belt starter generator with a tensioning system of claim 16, wherein a pulley force of the first and second pulleys are substantially aligned with one another facing in opposite directions toward one another.

18. The belt starter generator with a tensioning system of claim 10, wherein one of the first and second struts is longer than the other.
